(19) United States
(12) Patent Application Publication
(10) Pub. No.: US 2026/0328910 A1
(43) Pub. Date: Oct. 22, 2026

(54) FMCW LIDAR SYSTEM

(71) Applicant: BEIJING MORELITE TECHNOLOGY CO. LTD., Beijing (CN)

(72) Inventors: Yunsong WANG, Beijing (CN); Dongquan ZHANG, Beijing (CN); Tianbo SUN, Beijing (CN); Jie SUN, Beijing (CN)

(21) Appl. No.: 19/435,520

(22) Filed: Dec. 29, 2025

(30) Foreign Application Priority Data
Apr. 16, 2025 (CN) 202510480000.4

(51) Int. Cl. G01S 7/481; G01S 7/4911; G01S 7/4912; G01S 7/499; G01S 17/34; G01S 17/58

(52) U.S. Cl. CPC G01S 7/4814; G01S 7/4816; G01S 7/4817; G01S 7/4911; G01S 7/4917; G01S 7/499; G01S 17/34; G01S 17/58

(57) ABSTRACT

A FMCW lidar system is provided. The system comprises: a laser light source configured to emit frequency-swept laser; an optical engine including an optical transceiver, wherein the optical engine is configured to receive the frequency-swept laser, emit at least part of the frequency-swept laser as a detection beam from the optical transceiver; the detection beam is incident on an obstacle to generate a reflected beam, the optical transceiver is further configured to receive the reflected beam; a first scanning component configured to deflect the detection beam from the optical engine in a first direction to realize scanning of the detection beam in the first direction; a second scanning component configured to deflect the detection beam from the first scanning component in a second direction to realize scanning of the detection beam in the second direction; an optical module between the optical engine and the first scanning component.

### CROSS-REFERENCE TO RELATED APPLICATION

The present application claims a priority to Chinese Patent Application No. 202510480000.4 filed on Apr. 16, 2025, the disclosures of which are incorporated in their entirety by reference herein.

### TECHNICAL FIELD

The present application relates to the technical field of light detection and ranging (lidar), and in particular, to a Frequency-Modulated Continuous Wave (FMCW) lidar system.

### BACKGROUND

Lidar is a radar system that detects characteristic quantities such as the position and speed of a target by emitting laser beams. Its working principle is to emit a detection signal to the target, then compare the received signal reflected back from the target with the emitted signal, and after appropriate processing, obtain relevant information about the target, such as the target's distance, azimuth, height, speed, attitude, and even shape, thereby detecting, tracking, and identifying targets such as aircraft and missiles. Currently, lidar is widely deployed in various scenarios including autonomous vehicles. Lidar can actively estimate the distance and speed to environmental features when scanning a scene, and generate a point cloud indicating the three-dimensional shape of the environmental scene.

### SUMMARY

Some embodiments of the present application provide an FMCW lidar system, which comprises:
a laser light source configured to emit frequency-swept laser;
an optical engine including an optical transceiver, wherein the optical engine is configured to receive the frequency-swept laser, emit at least a part of the frequency-swept laser as a detection beam from the optical transceiver; the detection beam is incident on an obstacle to generate a reflected beam, and the optical transceiver is further configured to receive the reflected beam;
a first scanning component configured to deflect the detection beam from the optical engine in a first direction to realize scanning of the detection beam in the first direction;
a second scanning component configured to deflect the detection beam from the first scanning component in a second direction to realize scanning of the detection beam in the second direction;
an optical module disposed between the optical engine and the first scanning component, configured to allow the detection beam to pass through and change the shape of the detection beam, so that the instantaneous field of view (iFOV) of the FMCW lidar system in the first direction is different from that in the second direction.

In some embodiments, the scanning angular velocity of the second scanning component is greater than that of the first scanning component; the equivalent focal length f2 of the optical module in the second direction is smaller than the equivalent focal length f1 of the optical module in the first direction; and the instantaneous field of view of the detection beam in the second direction is larger than that in the first direction.

In some embodiments, the optical module comprises:
a collimating lens configured to collimate the detection beam, so that the cross-section of the detection beam passing through the collimating lens is circular; and
a prism assembly configured to change the shape of the detection beam, so that the cross-section of the detection beam passing through the prism assembly is elliptical, wherein the major axis of the ellipse extends along the first direction, and the minor axis of the ellipse extends along the second direction.

In some embodiments, the prism assembly comprises at least one triangular prism, the triangular prism includes an incident surface and an emergent surface; the detection beam enters the triangular prism through the incident surface and exits through the emergent surface; the compression ratio n of the detection beam in the second direction after passing through the triangular prism satisfies the following formula:

$$η = \frac{d 2}{d 1} = \frac{cos {r}_{1}}{cos {i}_{1}} \frac{cos {r}_{2}}{cos {i}_{2}} ; sin {r}_{1} = n sin {i}_{1} = sin {r}_{2} = n sin {i}_{2}$$

wherein, d2 represents the width of the cross-section of the detection beam in the second direction after passing through the triangular prism; d1 represents the width of the cross-section of the detection beam in the second direction before passing through the triangular prism; i₁ represents the incident angle of the detection beam on the incident surface of the triangular prism; r₁ represents the emergent angle of the detection beam on the incident surface of the triangular prism; i₂ represents the incident angle of the detection beam on the emergent surface of the triangular prism; r₂ represents the emergent angle of the detection beam on the emergent surface of the triangular prism; and n represents the refractive index of the triangular prism.

In some embodiments, the triangular prism is a right-angle prism; the detection beam is vertically incident from the right-angle surface of the right-angle prism and exits from the inclined surface of the right-angle prism; the compression ratio n of the detection beam in the second direction after passing through the right-angle prism satisfies the following formula:

$$η = \frac{d 2}{d 1} = \frac{cos {r}_{1}}{cos {i}_{1}} \frac{cos {r}_{2}}{cos {i}_{2}} ; sin {r}_{1} = n sin {i}_{1} = sin {r}_{2} = n sin {i}_{2}$$

wherein, d2 represents the width of the cross-section of the detection beam in the second direction after passing through the right-angle prism; d1 represents the width of the cross-section of the detection beam in the second direction before passing through the right-angle prism; i represents the incident angle of the detection beam on the inclined surface of the right-angle prism; I represents the emergent angle of the detection beam on the inclined surface of the right-angle prism; and n represents the refractive index of the right-angle prism.

In some embodiments, the prism assembly comprises at least one internal reflection triangular prism, the internal reflection triangular prism includes an incident surface, a reflection surface and an emergent surface; the detection beam enters the internal reflection triangular prism through the incident surface, is reflected by the reflection surface, and exits through the emergent surface; the detection beam is compressed in the second direction after passing through the internal reflection triangular prism.

In some embodiments, the first scanning component comprises a galvanometer, and the second scanning component comprises a pentagonal rotating mirror.

In some embodiments, the optical engine comprises a lidar chip, and the lidar chip comprises:
a frequency-swept laser receiving end configured to receive the frequency-swept laser;
an optical splitter connected to the laser receiving end, configured to split the frequency-swept laser into a detection beam and a local oscillator beam;
a mixer configured to receive the local oscillator beam and the reflected beam, and mix the local oscillator beam and the reflected beam to obtain mixed laser; and
a balanced detector configured to receive the mixed laser and output a detection electrical signal based on the mixed laser;
the FMCW lidar system further comprises:
an acquisition and processing device electrically connected to the balanced detector, configured to receive the detection electrical signal from the balanced detector, process the detection electrical signal, and determine the distance and/or speed of the obstacle relative to the FMCW lidar system.

In some embodiments, the lidar chip further comprises:
a polarization splitting rotator serving as the optical transceiver, configured to receive and output the detection beam, and receive the reflected beam and change the polarization direction of the reflected beam;
the mixer receives the local oscillator beam from the optical splitter and the reflected beam from the polarization splitting rotator.

In some embodiments, the lidar chip further comprises:
a detection beam emitting end configured to receive and output the detection beam from the optical splitter; and
a reflected beam receiving end configured to receive the reflected beam;
the optical transceiver comprises a circulator, the circulator includes a first port, a second port and a third port; the first port is connected to the detection beam emitting end, receives the detection beam emitted from the detection beam emitting end and transmits it to the second port; the detection beam is emitted from the second port; the second port also receives the reflected beam and transmits it to the third port; the third port is connected to the reflected beam receiving end, and transmits the reflected beam to the reflected beam receiving end.

Some embodiments of the present application provide a mobile device, which comprises the FMCW lidar system according to the foregoing embodiments.

### BRIEF DESCRIPTION OF THE DRAWINGS

The accompanying drawings herein are incorporated into the specification and constitute a part of the specification, showing embodiments consistent with the present application, and together with the specification, serve to explain the principles of the present application. Obviously, the drawings in the following description are only some embodiments of the present application. For those of ordinary skill in the art, other drawings can also be obtained according to these drawings without creative work.

FIG. 1 is a schematic structural diagram of an FMCW lidar system provided in some embodiments of the present application;

FIG. 2 is a schematic structural diagram of the optical module in FIG. 1;

FIG. 3 is a schematic structural diagram of the optical module in FIG. 1;

FIG. 4 is a schematic structural diagram of the optical module in FIG. 1;

FIG. 5 is a schematic structural diagram of the optical module in FIG. 1;

FIG. 6 is a schematic structural diagram of the optical module in FIG. 1;

FIG. 7 is a schematic structural diagram of an optical engine provided in some embodiments of the present application; and

FIG. 8 is a schematic structural diagram of an optical engine provided in some embodiments of the present application.

### DETAILED DESCRIPTION

In order to make the objectives, technical solutions, and advantages of the present application clearer, the present application will be further described in detail below with reference to the accompanying drawings. Obviously, the described embodiments are only a part of the embodiments of the present application, rather than all the embodiments. Based on the embodiments in the present application, all other embodiments obtained by those of ordinary skill in the art without creative work shall fall within the protection scope of the present application.

The terms used in the embodiments of the present application are only for the purpose of describing specific embodiments and are not intended to limit the present application. The singular forms “a”, “said”, and “the” used in the embodiments of the present application and the appended claims are also intended to include plural forms, unless the context clearly indicates otherwise, and “plural” generally includes at least two.

It should be understood that the term “and/or” used herein is only a description of the associated relationship of the associated objects, indicating that there can be three relationships, for example, A and/or B can indicate: A exists alone, A and B exist simultaneously, and B exists alone. In addition, the character “/” herein generally indicates that the associated objects before and after are in an “or” relationship.

It should be understood that although terms such as first, second, and third may be used in the embodiments of the present application to describe, they should not be limited to these terms. These terms are only used to distinguish. For example, without departing from the scope of the embodiments of the present application, the first may also be called the second, and similarly, the second may also be called the first.

It should also be noted that the terms “comprise”, “include”, or any other variant thereof are intended to cover a non-exclusive inclusion, so that a commodity or device including a series of elements not only includes those elements, but also includes other elements not explicitly listed, or elements inherent to the commodity or device. Without more restrictions, an element defined by the sentence “comprising one” does not exclude the existence of other identical elements in the commodity or device including the element.

In the related art, existing lidars mainly include the following two technical routes based on ranging methods: ToF (Time of Flight) and FMCW (Frequency-Modulated Continuous Wave).

The ranging principle of ToF is to calculate the distance by multiplying the flight time of light pulses between the target and the lidar by the speed of light. ToF lidars adopt pulse amplitude modulation technology. Different from the ToF route, FMCW mainly measures the frequency difference between transmission and reception by sending and receiving continuous laser beams, interfering the reflected light with the local oscillator light, and using heterodyne detection technology, then converts the frequency difference into the distance of the target. In short, ToF uses time to measure distance, while FMCW uses frequency to measure distance.

Compared with ToF, FMCW has the following advantages: the light wave of ToF is easily interfered by ambient light, while the light wave of FMCW has strong anti-interference ability; the signal-to-noise ratio of ToF is too low, while the signal-to-noise ratio of FMCW is very high; the speed dimension data quality of ToF is low, while FMCW can obtain speed dimension data of each pixel.

Lidars adopting the FMCW technical route have good technical advantages, but there are the following problems in their practical applications:

For traditional FMCW lidar systems, in order to reduce the size of the FMCW lidar system, each detection channel is usually corresponding to one optical transceiver. The detection beam and reflected beam of each detection channel are transmitted and received through the same port of the corresponding optical transceiver (hereinafter also referred to as the transceiver port). A lens is used to collimate the detection beam and couple the reflected beam to the same port. The detection channel where the transceiver port is located has an instantaneous field of view (iFOV), whose value is calculated by the formula

$$iFOV = \frac{MFD}{f} ,$$

where MFD is the mode field diameter of the transceiver port, and f is the effective focal length of the lens. The size of the instantaneous field of view determines the angular range of the beam that the same port can transmit/receive at a certain moment.

Traditional FMCW lidar systems also usually use scanning components (such as galvanometers, rotating mirrors, etc.) to realize one-dimensional or two-dimensional scanning of the detection beam. To meet the frame rate requirement of the lidar point cloud, the rotating mirror must reach a certain rotational angular velocity. Considering that during the ranging process, the beam will fly in the air for a period of time, including the time for the detection beam to transmit to the obstacle and the time for the reflected beam to return from the obstacle. During this period, the rotation of the scanning component does not stop, which is equivalent to a certain deviation between the emission and reception pointing angles of the above-mentioned transceiver port (i.e., the deviation between the pointing angle of the detection beam and the pointing angle of the received beam), which is called the transceiver offset angle. The transceiver offset angle can be described by the formula θθ=ω*Δt. When θ=0, the optical axes of the detection beam and the reflected beam are completely coincident, and the detection capability of the FMCW lidar system is the strongest. When 0<θ≤iFOV, the detection capability of the FMCW lidar system will decrease accordingly. When Δθ>iFOV, the transceiver port will be unable to detect the reflected beam.

In the related art, to solve the above problem, one transmission channel is corresponding to multiple reception channels, that is, the receiving port uses an array device (optical fiber/waveguide) to equivalently expand the iFOV of the receiving module. However, this solution increases the complexity of the system and resource consumption, and also leads to problems such as reduced reliability and significantly increased cost.

The present application provides an FMCW lidar system, which is wherein the FMCW lidar system comprises: a laser light source configured to emit frequency-swept laser; an optical engine including an optical transceiver, wherein the optical engine is configured to receive the frequency-swept laser, emit at least a part of the frequency-swept laser as a detection beam from the optical transceiver; the detection beam is incident on an obstacle to generate a reflected beam, and the optical transceiver is further configured to receive the reflected beam; a first scanning component configured to deflect the detection beam from the optical engine in a first direction to realize scanning of the detection beam in the first direction; a second scanning component configured to deflect the detection beam from the first scanning component in a second direction to realize scanning of the detection beam in the second direction; an optical module disposed between the optical engine and the first scanning component, configured to allow the detection beam to pass through and change the shape of the detection beam, so that the instantaneous field of view (iFOV) of the FMCW lidar system in the first direction is different from that in the second direction.

The FMCW (Frequency-Modulated Continuous Wave) lidar system in the present application changes the shape of the detection beam passing through the optical module by arranging the optical module, so that the FMCW lidar system has different instantaneous fields of view in different scanning directions. While ensuring the overall light-receiving capability of the FMCW lidar system, it also ensures the detection performance of the FMCW lidar system. A larger instantaneous field of view is provided in the fast scanning direction to compensate for the transceiver offset angle in this direction, and a smaller instantaneous field of view is provided in the slow scanning direction to ensure the overall light-receiving capability of the FMCW lidar system.

The optional embodiments of the present application are described in detail below with reference to the accompanying drawings.

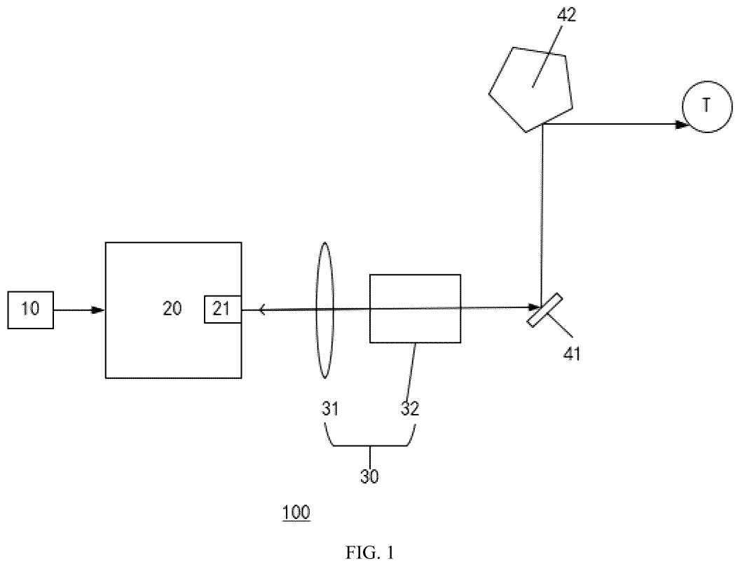

FIG. 1 is a schematic structural diagram of an FMCW lidar system provided in some embodiments of the present application. The FMCW lidar system 100 comprises a laser light source 10, an optical engine 20, an optical module 30, a first scanning component 41, and a second scanning component 42.

The laser light source 10 is configured to emit frequency-swept laser, and the frequency of the frequency-swept laser changes with time (e.g., a periodic triangular wave). The laser light source 10 can be directly modulated by an electrical signal. That is, the electrical signal driving the laser light source 10 can change with time, so that the laser light source 10 generates and outputs frequency-swept laser (i.e., a beam whose frequency changes within a predetermined range). In some embodiments, the laser light source 10 can also use a modulator to frequency-modulate the output constant-frequency laser to realize the output of frequency-swept laser. Specifically, the frequency of the laser beam output by the laser light source 10 is substantially constant (referred to as the frequency of the unmodulated beam, e.g., 100-300 THz). The modulator receives the laser beam with substantially constant frequency and a modulation signal, and under the action of the modulation signal, the modulator modulates the laser beam with substantially constant frequency into a frequency-swept beam whose frequency changes with time and outputs it.

The optical engine 20 includes an optical transceiver 21. The optical engine 20 is configured to receive the frequency-swept laser emitted by the laser light source 10, and emit at least a part of the frequency-swept laser as a detection beam from the optical transceiver 21. The detection beam is incident on an obstacle T to generate a reflected beam, and the optical transceiver 21 is further configured to receive the reflected beam. The FMCW lidar system 100 measures the distance of the test point on the obstacle T according to the reflected beam (which can be understood as the distance between the test point on the obstacle T and the FMCW lidar system 100).

The first scanning component 41 is configured to deflect the detection beam from the optical engine 20 in a first direction to realize scanning of the detection beam in the first direction. The first direction is, for example, the vertical direction Y (the direction perpendicular to the paper surface shown in FIG. 1 is the vertical direction, and the paper surface direction is the horizontal direction X).

The second scanning component 42 is configured to deflect the detection beam from the first scanning component 41 in a second direction to realize scanning of the detection beam in the second direction. The second direction is, for example, the horizontal direction.

The first scanning component 41 and the second scanning component 42 cooperate to enable the detection beam to pass through the first scanning component 41 and the second scanning component 42 in sequence to realize two-dimensional scanning. In this way, the FMCW lidar system can still realize a large scanning area even with fewer detection channels.

Each of the first scanning component 41 and the second scanning component 42 is, for example, a rotating mirror, a rotating prism, a rotating optical wedge, a galvanometer, a MEMS (Micro-Electro-Mechanical System), etc. It can realize the scanning of the detection beam through its regular movement (i.e., using a line lidar for surface detection), thereby obtaining the test information of each test point on the surface of the obstacle, forming a laser point cloud, and thus determining the three-dimensional structure of the obstacle.

The optical module 30 is disposed between the optical engine 20 and the first scanning component 41, configured to allow the detection beam to pass through and change the shape of the detection beam, so that the instantaneous field of view (iFOV) of the FMCW lidar system 100 in the first direction (e.g., vertical direction) is different from that in the second direction (e.g., horizontal direction). For example, the optical module 30 can change the cross-sectional shape of the detection beam from a circle to an ellipse, so that the FMCW lidar system has different instantaneous fields of view in different scanning directions. While ensuring the overall light-receiving capability of the FMCW lidar system, it also ensures the detection performance of the FMCW lidar system. A larger instantaneous field of view is provided in the fast scanning direction to compensate for the transceiver offset angle in this direction, and a smaller instantaneous field of view is provided in the slow scanning direction to ensure the overall light-receiving capability of the FMCW lidar system 100.

In some embodiments, the scanning angular velocity of the second scanning component 41 is greater than that of the first scanning component 41. That is, the scanning speed of the FMCW lidar system 100 in the horizontal direction is greater than that in the vertical direction.

The equivalent focal length fx of the optical module 30 in the second direction (e.g., horizontal direction) is smaller than the equivalent focal length fy of the optical module in the first direction (e.g., vertical direction), and the instantaneous field of view iFOVx of the detection beam in the second direction (e.g., horizontal direction) is larger than the instantaneous field of view iFOVy in the first direction (e.g., vertical direction).

The value of the instantaneous field of view (iFOV) is calculated by the formula iFOV=, where MFD is the mode field diameter of the transceiver port, and f is the effective focal length of the lens. The size of the instantaneous field of view (iFOV) determines the angular range of the beam that the same port can transmit/receive at a certain moment. Since the FMCW lidar system 100 scans faster in the second direction (e.g., horizontal direction) and slower in the first direction (e.g., vertical direction), the above-mentioned problem that the reflected beam cannot be received normally due to the transceiver offset angle only occurs in the horizontal direction, and has no impact in the vertical direction. In this embodiment, the optical module can be designed such that the equivalent focal length fx of the optical module in the second direction (e.g., horizontal direction) is smaller than the equivalent focal length fy of the optical module in the first direction (e.g., vertical direction). Further, based on the above formula, the instantaneous field of view iFOVx of the detection beam in the second direction (e.g., horizontal direction) is larger than the instantaneous field of view iFOVy in the first direction (e.g., vertical direction), which solves the problem that the reflected beam cannot be detected normally due to the transceiver offset angle in the horizontal direction.

According to the above principle of “transceiver offset angle”, increasing the iFOV of the transceiver system can solve the problem that the transceiver port cannot detect the reflected beam normally to a certain extent. However, when the iFOV is increased, the light-receiving capability of the entire system will inevitably decrease. The specific reason is as follows: when a collimating lens with a focal length f is used as the optical module, its instantaneous field of view is

$$iFOV = \frac{MFD}{f} ,$$

where MFD is the mode field diameter of the transceiver port. According to the characteristics of Gaussian beams, the effective light-receiving diameter of the optical module is

$$d = \frac{4 λ f}{π * MFD} = \frac{4 λ}{π * iFOV} ,$$

where λ is the center wavelength of the detection beam. The light-receiving capability of the FMCW lidar system can be evaluated by the effective spot area S, which is

$$S = \frac{π {d}^{2}}{4} = \frac{4 {λ}^{2}}{π} * {( \frac{f}{MFD} )}^{2} = \frac{4 {λ}^{2}}{π} * \frac{1}{{iFOV}^{2}} .$$

Therefore, when the instantaneous field of view (iFOV) increases, the light-receiving capability of the FMCW lidar system decreases rapidly, and the two are in an inverse quadratic relationship.

As mentioned above, the FMCW lidar system shown in FIG. 1 only scans faster in the horizontal direction and slower in the vertical direction. Therefore, the phenomenon of “transceiver offset angle” only occurs in the horizontal direction, and there is no such problem in the vertical direction. Based on the above logic, the embodiments of the present application propose to design the instantaneous fields of view (iFOV) of the detection beam spot in the horizontal and vertical directions to different values: increase the instantaneous field of view (iFOV) in the horizontal direction to compensate for the transceiver angle deviation, and decrease the iFOV in the vertical direction to increase the light-receiving capability.

In the FMCW lidar system in the related art, if the focal length of the collimating lens used as the optical module is fo, the instantaneous field of view in the horizontal or vertical direction is

$${iFOV}_{o} = \frac{MFD}{{f}_{o}} ,$$

and the effective light-receiving area of the entire system is

$${S}_{o} = \frac{4 {λ}^{2}}{π} * \frac{1}{{iFOV}_{o}^{2}} .$$

According to the improvement idea in the embodiments of the present application, the equivalent focal lengths of the optical module in different directions are set to different values by designing the optical module, thereby generating different instantaneous fields of view in different directions. Specifically, the equivalent focal length in the horizontal direction (corresponding to high scanning angular velocity) is designed as

$${f}_{x} = \frac{{f}_{0}}{2} ,$$

and the equivalent focal length in the vertical direction (corresponding to low scanning angular velocity) is designed as f_{y}=2fₒ. Correspondingly, the instantaneous field of view in the horizontal direction is

$${iFOV}_{x} = \frac{MFD}{{f}_{x}} = 2 {iFOV}_{o} ,$$

and the instantaneous field of view in the horizontal direction is

$${iFOV}_{y} = \frac{MFD}{{f}_{y}} = \frac{1}{2} {iFOV}_{o}$$

The effective diameter in the horizontal direction is

$${d}_{x} = \frac{4 λ}{π * {iFOV}_{x}} = \frac{2 λ}{π * {iFOV}_{o}} ,$$

and the effective diameter in the vertical direction is

$${d}_{y} = \frac{4 λ}{π * {iFOV}_{y}} = \frac{8 λ}{π * {iFOV}_{o}} .$$

The overall light-receiving area of the system is

$$S = \frac{π {d}_{x} {d}_{y}}{4} = \frac{4 {λ}^{2}}{π} * \frac{1}{{iFOV}_{o}^{2}} ,$$

which is equal to the light-receiving area So of the system before improvement. That is, on the basis of keeping the light-receiving capability of the entire system unchanged, the instantaneous field of view in the horizontal direction is increased, and the instantaneous field of view in the vertical direction is decreased, which ensures the detection performance of the FMCW lidar system while ensuring the overall light-receiving capability of the FMCW lidar system.

The specific design of the optical module 30 to change the shape of the detection beam passing through the optical module so that the FMCW lidar system has different instantaneous fields of view in different scanning directions is discussed in detail below.

In some embodiments, as shown in FIG. 1, the optical module 30 comprises a collimating lens 31 and a prism assembly 32.

The collimating lens 31 is configured to collimate the detection beam, so that the detection beam passing through the collimating lens is a parallel beam, and its cross-section is, for example, circular. The collimating lens 31 is disposed on the side of the optical transceiver 21, and is used to collimate the detection beam and couple the reflected beam into the optical transceiver 21. The collimating lens 31 can be a single lens or a lens group, which has the functions of focusing and collimation. Specifically, the collimating lens 31 collimates the detection beam emitted from the optical transceiver 21 to form a parallel beam, so as to ensure its propagation distance. The detection beam reaches the obstacle to generate a reflected beam, and the reflected beam is focused and coupled into the optical transceiver 21 by the collimating lens 31, which is beneficial to the subsequent detection of the FMCW lidar system.

The prism assembly 32 is configured to change the shape of the detection beam, so that the cross-section of the detection beam passing through the prism assembly 32 is elliptical, where the major axis extends along the first direction (e.g., vertical direction) and the minor axis extends along the second direction (e.g., horizontal direction). That is, the prism assembly 32 compresses the detection beam in the second direction (e.g., horizontal direction), so that the equivalent focal length fx of the optical module 30 in the second direction (e.g., horizontal direction) is smaller than the equivalent focal length fy of the optical module in the first direction (e.g., vertical direction). Further, based on the above formula, the instantaneous field of view iFOVx of the detection beam in the second direction (e.g., horizontal direction) is larger than the instantaneous field of view iFOVy in the first direction (e.g., vertical direction).

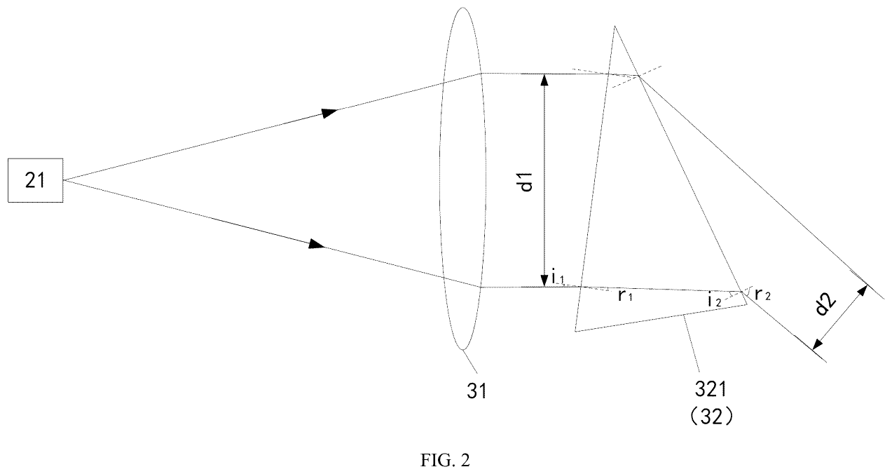

FIG. 2 is a schematic structural diagram of the optical module in FIG. 1. In FIG. 2, the paper surface represents the horizontal direction, and the direction perpendicular to the paper surface represents the vertical direction. In some embodiments, as shown in FIG. 2, the prism assembly 32 comprises a triangular prism 321. The detection beam is incident from the incident surface of the triangular prism 321 and exits from the emergent surface of the triangular prism 321. The compression ratio n of the detection beam in the second direction after passing through the triangular prism 321 satisfies the following formula:

$$η = \frac{d 2}{d 1} = \frac{cos {r}_{1}}{cos {i}_{1}} \frac{cos {r}_{2}}{cos {i}_{2}} ; sin {r}_{1} = n sin {i}_{1} , sin {r}_{2} = n sin {i}_{2}$$

wherein, d2 represents the width of the cross-section of the detection beam in the second direction after passing through the triangular prism 321; d1 represents the width of the cross-section of the detection beam in the second direction before passing through the triangular prism; i₁ represents the incident angle of the detection beam on the incident surface of the triangular prism; r₁ represents the emergent angle of the detection beam on the incident surface of the triangular prism; i₂ represents the incident angle of the detection beam on the emergent surface of the triangular prism; r₂ represents the emergent angle of the detection beam on the emergent surface of the triangular prism; and n represents the refractive index of the right-angle prism.

Through the cooperation of the triangular prism 321 and the collimating lens 31, the width of the detection beam is compressed in the horizontal direction, and the width of the detection beam is kept unchanged in the vertical direction, so that the cross-section of the detection beam passing through the triangular prism 321 changes from a circle to an ellipse. This makes the equivalent focal length fx of the optical module 30 in the horizontal direction smaller than the equivalent focal length fy in the vertical direction, and the instantaneous field of view iFOVx of the detection beam in the horizontal direction larger than the instantaneous field of view iFOVy in the vertical direction.

As mentioned above, the structure and material of the triangular prism 321 determine its compression ratio n for the detection beam in the horizontal direction. If a single triangular prism cannot meet the compression ratio required by the FMCW lidar system, multiple triangular prisms can be arranged to compress the detection beam sequentially.

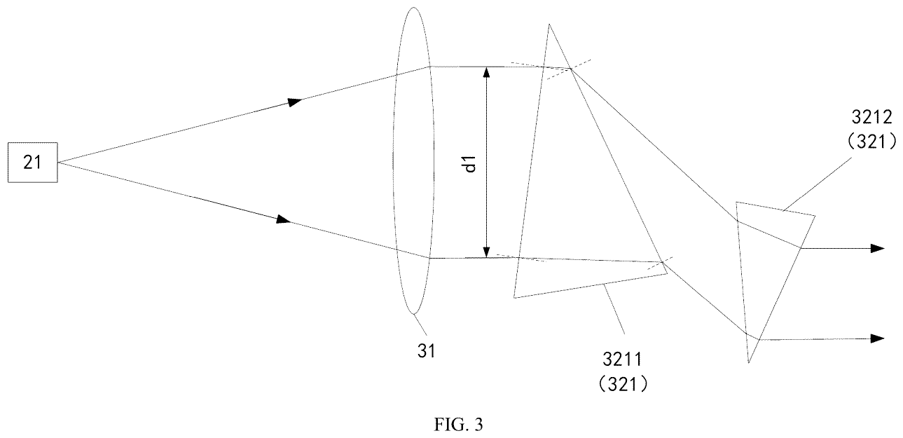

FIG. 3 is a schematic structural diagram of the optical module in FIG. 1. In FIG. 3, the paper surface represents the horizontal direction, and the direction perpendicular to the paper surface represents the vertical direction. In some embodiments, as shown in FIG. 3, the triangular prism 321 comprises a first triangular prism 3211 and a second triangular prism 3212. The detection beam collimated by the collimating lens 31 passes through the first triangular prism 3211 and the second triangular prism 3212 in sequence, so that the detection beam is compressed twice in the horizontal direction. The overall compression ratio is η=η1×η2, where η1 is the compression ratio of the first triangular prism 3211 for the detection beam in the horizontal direction, and η2 is the compression ratio of the second triangular prism 3212 for the detection beam in the horizontal direction.

As shown in FIG. 2, when the detection beam passes through the triangular prism 321, its emergent direction will deflect in the horizontal direction relative to the original transmission path. The structure shown in FIG. 3 can be used to set the positional relationship between the two right-angle prisms, so that the emergent direction of the detection beam after passing through the two triangular prisms is substantially parallel to the original transmission direction.

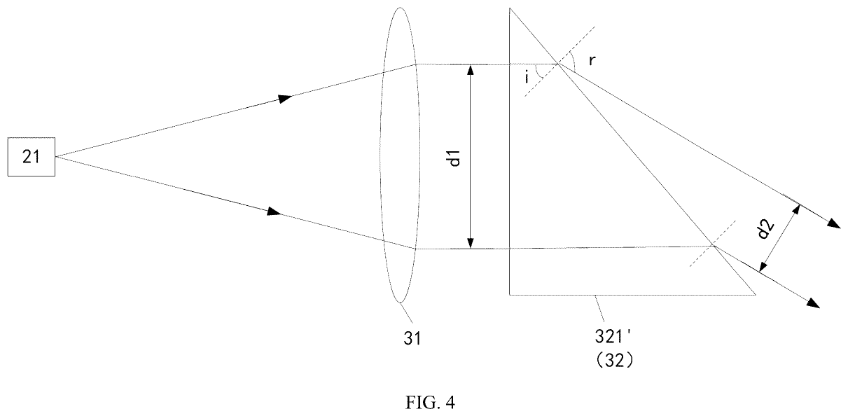

FIG. 4 is a schematic structural diagram of the optical module in FIG. 1. In FIG. 4, the paper surface represents the horizontal direction, and the direction perpendicular to the paper surface represents the vertical direction. In some embodiments, as shown in FIG. 2, the triangular prism 321 is, for example, a right-angle prism 321′. The detection beam is vertically incident from the right-angle surface of the right-angle prism 321′ and exits from the inclined surface of the right-angle prism 321′. The compression ratio n of the detection beam in the second direction after passing through the right-angle prism 321′ satisfies the following formula:

$$η = - \frac{d 2}{d 1} = \frac{cos r}{cos i} ; sin r = n sin i$$

Wherein, d2 represents the width of the cross-section of the detection beam in the second direction (e.g., horizontal direction) after passing through the right-angle prism 321′; d1 represents the width of the cross-section of the detection beam in the second direction (e.g., horizontal direction) before passing through the right-angle prism 321′; i represents the incident angle of the detection beam on the inclined surface of the right-angle prism; I represents the emergent angle of the detection beam on the inclined surface of the right-angle prism; and n represents the refractive index of the right-angle prism.

Through the cooperation of the right-angle prism 321′ and the collimating lens 31, the width of the detection beam is compressed in the horizontal direction, and the width of the detection beam is kept unchanged in the vertical direction, so that the cross-section of the detection beam passing through the right-angle prism 321′ changes from a circle to an ellipse. This makes the equivalent focal length fx of the optical module 30 in the horizontal direction smaller than the equivalent focal length fy in the vertical direction, and the instantaneous field of view iFOVx of the detection beam in the horizontal direction larger than the instantaneous field of view iFOVy in the vertical direction.

As mentioned above, the structure and material of the right-angle prism 321′ determine its compression ratio η for the detection beam in the horizontal direction. If a single right-angle prism cannot meet the compression ratio required by the FMCW lidar system, multiple right-angle prisms can be arranged to compress the detection beam sequentially.

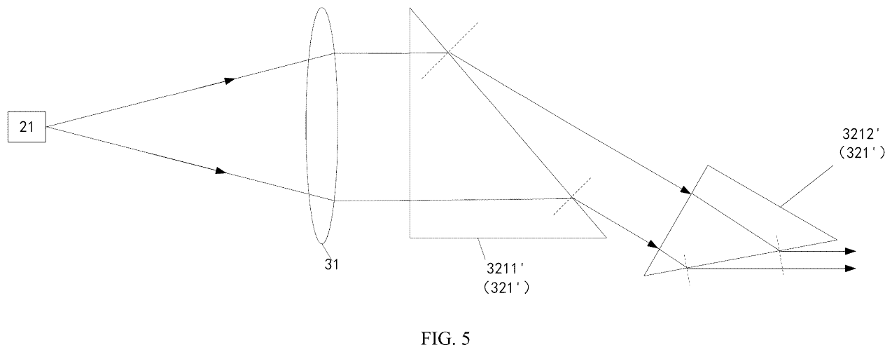

FIG. 5 is a schematic structural diagram of the optical module in FIG. 1. In FIG. 5, the paper surface represents the horizontal direction, and the direction perpendicular to the paper surface represents the vertical direction. In some embodiments, as shown in FIG. 5, the right-angle prism 321′ comprises a first right-angle prism 3211′ and a second right-angle prism 3212′. The detection beam collimated by the collimating lens 31 passes through the first right-angle prism 3211′ and the second right-angle prism 3212′ in sequence, so that the detection beam is compressed twice in the horizontal direction. The overall compression ratio is η=η1×η2, where η1 is the compression ratio of the first right-angle prism 3211′ for the detection beam in the horizontal direction, and η2 is the compression ratio of the second right-angle prism 3212′ for the detection beam in the horizontal direction.

As shown in FIG. 4, when the detection beam passes through the right-angle prism 321′, its emergent direction will deflect in the horizontal direction relative to the original transmission path. The structure shown in FIG. 5 can be used to set the positional relationship between the two right-angle prisms, so that the emergent direction of the detection beam after passing through the two right-angle prisms is substantially parallel to the original transmission direction.

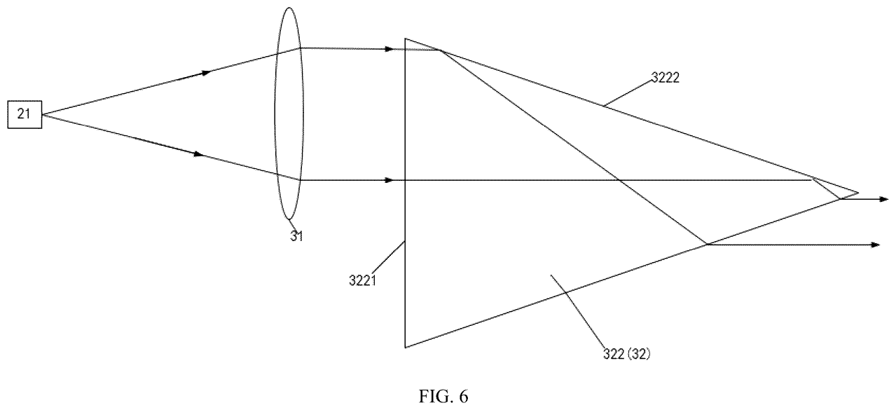

FIG. 6 is a schematic structural diagram of the optical module in FIG. 1. In FIG. 6, the paper surface represents the horizontal direction, and the direction perpendicular to the paper surface represents the vertical direction. In some embodiments, as shown in FIG. 4, the prism assembly 32 comprises at least one triangular prism 322. The triangular prism 322 includes an incident surface 3221, a reflection surface 3222, and an emergent surface 3223. The detection beam enters the triangular prism 322 through the incident surface 3221, is reflected by the reflection surface 3222, and exits through the emergent surface 3223. The detection beam is compressed in the second direction (e.g., horizontal direction) after passing through the triangular prism 322. By adjusting the structure and material of the triangular prism 322 and the positional relationship between the triangular prism 322 and the collimating lens 31, the detection beam compressed in the horizontal direction by the triangular prism can be transmitted parallel to the original transmission direction.

In some embodiments, as shown in FIG. 1, the first scanning component 41 comprises a galvanometer, which deflects in the first direction (e.g., vertical direction) to realize the scanning of the detection beam in the vertical direction. The second scanning component 52 comprises a pentagonal rotating mirror, whose rotation axis is in the vertical direction. It rotates at a high speed to realize the scanning of the detection beam in the horizontal direction.

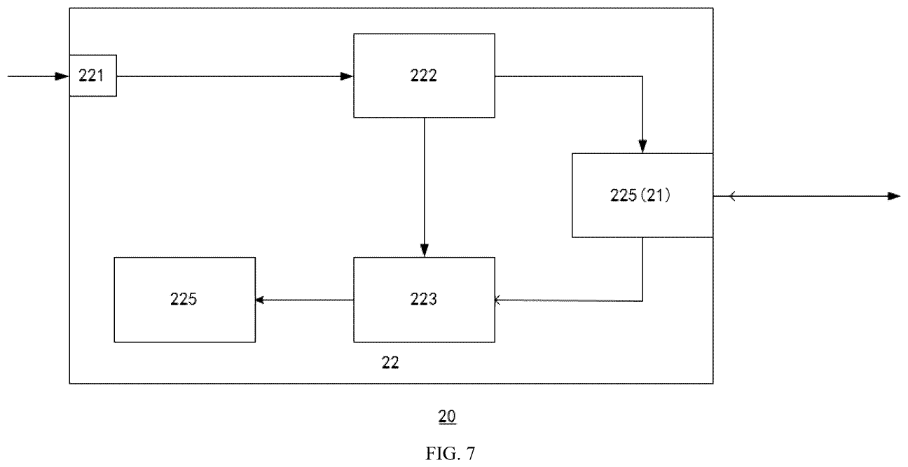

FIG. 7 is a schematic structural diagram of an optical engine provided in some embodiments of the present application. As shown in FIG. 7, the optical engine 20 comprises a lidar chip 22, and the lidar chip 22 comprises a frequency-swept laser receiving end 221, an optical splitter 222, a mixer 223, and a balanced detector 224. The use of a lidar chip can miniaturize the overall structure of the FMCW lidar system.

The frequency-swept laser receiving end 221 is configured to receive the frequency-swept laser emitted by the laser light source 10, and introduce the frequency-swept laser (e.g., a TE-mode polarized beam) into the lidar chip 22.

The optical splitter 222 is connected to the laser receiving end 221, and is configured to split the frequency-swept laser into a detection beam and a local oscillator beam. The optical splitter 222 is, for example, a 1×2 optical splitter, which splits the detection frequency-swept laser into two identical laser beams (i.e., the wavelength, phase, and frequency modulation of the detection beam and the local oscillator beam are completely the same).

The mixer 223 is connected to the optical splitter 222, and is configured to receive the local oscillator laser from the optical splitter 222. The mixer 223 is also configured to receive the local oscillator beam and the reflected beam, and mix the local oscillator beam and the reflected beam to obtain mixed laser (i.e., a detection beat frequency beam).

The balanced detector 224 is connected to the mixer 223, receives the mixed laser from the mixer 223, and outputs a detection electrical signal based on the mixed laser. The FMCW lidar system 100 determines the distance of the obstacle based on the detection optical signal.

In some embodiments, as shown in FIG. 7, the lidar chip 22 further comprises a polarization splitting rotator 225. The polarization splitting rotator 225 serves as the optical transceiver, and is configured to receive and output the detection beam, and receive the reflected beam and change the polarization direction of the reflected beam. Integrating the polarization splitting rotator 225 as an optical transceiver on the lidar chip 22 can further reduce the size of the optical engine 20, thereby reducing the size of the FMCW lidar system.

Specifically, the polarization splitting rotator 225 is connected to the optical splitter 222, receives the detection beam (e.g., a TE-mode polarized beam) output by the optical splitter 222, and outputs it from the transceiver port of the polarization splitting rotator 225. At this time, the TE-mode polarized beam is output from the lidar chip 22 and propagates in space. For example, it reaches the obstacle T after passing through the lens module 30, the birefringent component 50, and the scanning component 40. The TE-mode detection beam is reflected on the surface of the obstacle T to generate a reflected beam (e.g., a TM-mode polarized beam). The reflected beam is coupled into the transceiver port of the polarization splitting rotator 225, forms a TM-mode polarized beam after passing through the polarization splitting rotator 225, and is input to the mixer 223. The mixer 223 receives the local oscillator beam (e.g., a TE-mode polarized beam) from the optical splitter 222 and the reflected beam from the polarization splitting rotator.

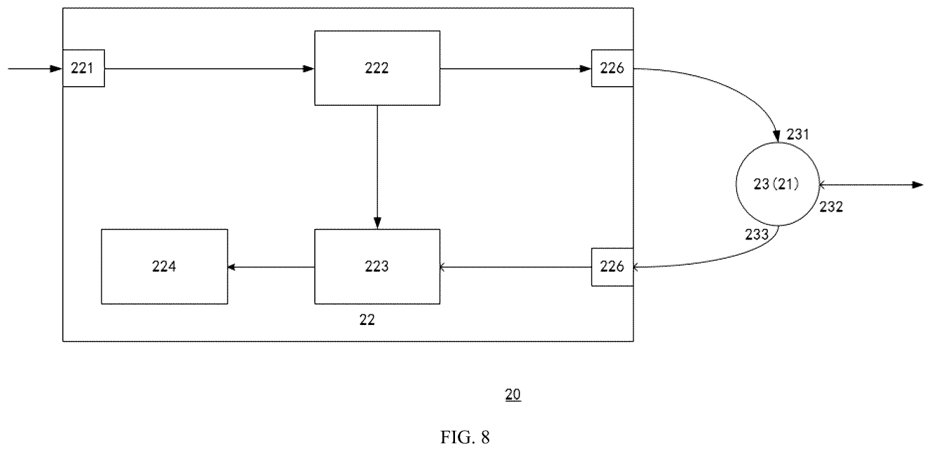

FIG. 8 is a schematic structural diagram of an optical engine provided in some embodiments of the present application. In some embodiments, as shown in FIG. 8, compared with the embodiment described in FIG. 7, the lidar chip 22 comprises the aforementioned frequency-swept laser receiving end 221, optical splitter 222, mixer 223, and balanced detector 224, but does not comprise the polarization splitting rotator 225.

The lidar chip 22 further comprises a detection beam emitting end 226 and a reflected beam receiving end 227. The detection beam emitting end 226 is connected to the optical splitter 222, and is configured to receive and output the detection beam from the optical splitter 222. The reflected beam receiving end 227 is configured to receive the reflected beam, and is connected to the mixer 223, and is configured to transmit the received reflected beam to the mixer 223.

The optical transceiver 21 comprises, for example, a circulator 23. The circulator includes a first port 231, a second port 232, and a third port 233. The first port 231 is connected to the detection beam emitting end 226 of the lidar chip 22, receives the detection beam emitted from the detection beam emitting end 226, and transmits it to the second port 232. The second port 232 of the circulator 23 is a transceiver port 211 of the optical transceiver 21, which transmits and receives the detection beam and the reflected beam coaxially. Specifically, the detection beam is emitted from the second port, propagates in space, and reaches the obstacle T after passing through the lens module 30, the birefringent component 50, and the scanning component 40, generating a reflected beam. The reflected beam is coupled into the second port 232 of the circulator 23 after passing through the scanning component 40, the birefringent component 50, and the lens module 30. The reflected beam coupled into the second port 232 from the second port 231 can only be transmitted to the second port 231 of the circulator 23. The second port also receives the reflected beam and transmits it to the third port 233. The third port 233 is connected to the reflected beam receiving end 227 of the lidar chip 22, and transmits the reflected beam to the reflected beam receiving end 227.

In some embodiments, the FMCW lidar system further comprises: an acquisition and processing device (not shown in the figure). The acquisition and processing device is electrically connected to the balanced detector 224, receives the detection electrical signal from the balanced detector 224, processes the detection electrical signal, and determines the distance and/or speed of the obstacle. In some embodiments, the acquisition and processing device comprises an analog-to-digital conversion module and a signal processing module. The analog-to-digital conversion module is, for example, an analog-to-digital converter, which receives the detection electrical signal from the balanced detector 224 (the detection electrical signal is an analog signal) and converts the analog detection electrical signal into a digital signal. The signal processing module is connected to the analog-to-digital conversion module, receives the digital signal from the analog-to-digital conversion module, processes the digital signal, and further determines the distance and/or speed of the detected target. In some embodiments, the signal processing module is, for example, a Field-Programmable Gate Array (FPGA), a Digital Signal Processor (DSP), or the like.

Some embodiments of the present application provide a mobile device, which comprises the FMCW lidar system according to the foregoing embodiments. The mobile device can be a vehicle, such as an unmanned cleaning vehicle, an unmanned logistics vehicle, an autonomous vehicle, etc.

Compared with the related art, the above solutions of the embodiments of the present application have at least the following beneficial effects:

The FMCW (Frequency-Modulated Continuous Wave) lidar system in the present application changes the shape of the detection beam passing through the optical module by arranging the optical module, so that the FMCW lidar system has different instantaneous fields of view in different scanning directions. While ensuring the overall light-receiving capability of the FMCW lidar system, it also ensures the detection performance of the FMCW lidar system. A larger instantaneous field of view is provided in the fast scanning direction to compensate for the transceiver offset angle in this direction, and a smaller instantaneous field of view is provided in the slow scanning direction to ensure the overall light-receiving capability of the FMCW lidar system.

The various parts in this specification are described in a combination of parallel and progressive manners. Each part focuses on the differences from other parts, and the same or similar parts between the various parts can be referred to each other.

The above description of the disclosed embodiments enables those skilled in the art to implement or use the present application. Various modifications to these embodiments will be obvious to those skilled in the art, and the general principles defined herein can be implemented in other embodiments without departing from the spirit or scope of the present application. Therefore, the present application will not be limited to the embodiments shown herein, but should conform to the widest scope consistent with the principles and novel features disclosed herein.

Finally, it should be noted that the various embodiments in this specification are described in a progressive manner, and each embodiment focuses on the differences from other embodiments. The same or similar parts between the various embodiments can be referred to each other. For the systems or devices disclosed in the embodiments, since they correspond to the methods disclosed in the embodiments, the description is relatively simple, and the relevant parts can be referred to the description of the method part.

The above embodiments are only used to illustrate the technical solutions of the present application, not to limit them. Although the present application has been described in detail with reference to the foregoing embodiments, those of ordinary skill in the art should understand that they can still modify the technical solutions described in the foregoing embodiments, or equivalently replace some of the technical features; and these modifications or replacements do not make the essence of the corresponding technical solutions deviate from the spirit and scope of the technical solutions of the various embodiments of the present application.

What is claimed is:

1. A Frequency-Modulated Continuous Wave (FMCW) lidar system, wherein the FMCW lidar system comprises:
a laser light source configured to emit frequency-swept laser;
an optical engine including an optical transceiver, wherein the optical engine is configured to receive the frequency-swept laser, emit at least a part of the frequency-swept laser as a detection beam from the optical transceiver; the detection beam is incident on an obstacle to generate a reflected beam, and the optical transceiver is further configured to receive the reflected beam;
a first scanning component configured to deflect the detection beam from the optical engine in a first direction to realize scanning of the detection beam in the first direction;
a second scanning component configured to deflect the detection beam from the first scanning component in a second direction to realize scanning of the detection beam in the second direction;
an optical module disposed between the optical engine and the first scanning component, configured to allow the detection beam to pass through and change a shape of the detection beam, so that an instantaneous field of view of the FMCW lidar system in the first direction is different from that in the second direction.

2. The FMCW lidar system according to claim 1, wherein a scanning angular velocity of the second scanning component is greater than that of the first scanning component; an equivalent focal length f2 of the optical module in the second direction is smaller than an equivalent focal length f1 of the optical module in the first direction; and an instantaneous field of view of the detection beam in the second direction is larger than that in the first direction.

3. The FMCW lidar system according to claim 1, wherein the optical module comprises:
a collimating lens configured to collimate the detection beam, so that a cross-section of the detection beam passing through the collimating lens is circular; and
a prism assembly configured to change the shape of the detection beam, so that a cross-section of the detection beam passing through the prism assembly is elliptical, wherein a major axis of the ellipse extends along the first direction, and a minor axis of the ellipse extends along the second direction.

4. The FMCW lidar system according to claim 3, wherein the prism assembly comprises at least one triangular prism, the triangular prism includes an incident surface and an emergent surface; the detection beam enters the triangular prism through the incident surface and exits through the emergent surface; a compression ratio n of the detection beam in the second direction after passing through the triangular prism satisfies the following formula:
$$η = \frac{d 2}{d 1} = \frac{cos {r}_{1}}{cos {i}_{1}} \frac{cos {r}_{2}}{cos {i}_{2}} ; {sin}_{{r}_{1}} = n sin {i}_{1} , sin {r}_{2} = n sin {i}_{2}$$
wherein, d2 represents a width of the cross-section of the detection beam in the second direction after passing through the triangular prism; d1 represents a width of the cross-section of the detection beam in the second direction before passing through the triangular prism; i₁ represents an incident angle of the detection beam on the incident surface of the triangular prism; r₁ represents a emergent angle of the detection beam on the incident surface of the triangular prism; i₂ represents an incident angle of the detection beam on the emergent surface of the triangular prism; r₂ represents a emergent angle of the detection beam on the emergent surface of the triangular prism; and n represents the refractive index of the triangular prism.

5. The FMCW lidar system according to claim 4, wherein the triangular prism is a right-angle prism; the detection beam is vertically incident from a right-angle surface of the right-angle prism and exits from an inclined surface of the right-angle prism; a compression ratio n of the detection beam in the second direction after passing through the right-angle prism satisfies the following formula:
$$η = - \frac{d 2}{d 1} = \frac{cos r}{cos i} ; sin r = n sin i$$
wherein, d2 represents a width of the cross-section of the detection beam in the second direction after passing through the right-angle prism; d1 represents a width of the cross-section of the detection beam in the second direction before passing through the right-angle prism; i represents an incident angle of the detection beam on the inclined surface of the right-angle prism; r represents a emergent angle of the detection beam on the inclined surface of the right-angle prism; and n represents a refractive index of the right-angle prism.

6. The FMCW lidar system according to claim 3, wherein the prism assembly comprises at least one internal reflection triangular prism, the at least one internal reflection triangular prism includes an incident surface, a reflection surface and an emergent surface; the detection beam enters the internal reflection triangular prism through the incident surface, is reflected by the reflection surface, and exits through the emergent surface; the detection beam is compressed in the second direction after passing through the internal reflection triangular prism.

7. The FMCW lidar system according to claim 1, wherein the first scanning component comprises a galvanometer, and the second scanning component comprises a pentagonal rotating mirror.

8. The FMCW lidar system according to claim 1, wherein the optical engine comprises a lidar chip, and the lidar chip comprises:
a frequency-swept laser receiving end configured to receive the frequency-swept laser;
an optical splitter connected to the laser receiving end, configured to split the frequency-swept laser into a detection beam and a local oscillator beam;
a mixer configured to receive the local oscillator beam and the reflected beam, and mix the local oscillator beam and the reflected beam to obtain a mixed laser; and
a balanced detector configured to receive the mixed laser and output a detection electrical signal based on the mixed laser;
the FMCW lidar system further comprises:
an acquisition and processing device electrically connected to the balanced detector, configured to receive the detection electrical signal from the balanced detector, process the detection electrical signal, and determine the distance and/or speed of the obstacle relative to the FMCW lidar system.

9. The FMCW lidar system according to claim 8, wherein the lidar chip further comprises:
a polarization splitting rotator serving as the optical transceiver, configured to receive and output the detection beam, and receive the reflected beam and change a polarization direction of the reflected beam;
the mixer receives the local oscillator beam from the optical splitter and the reflected beam from the polarization splitting rotator.

10. The FMCW lidar system according to claim 8, wherein the lidar chip further comprises:
a detection beam emitting end configured to receive and output the detection beam from the optical splitter; and
a reflected beam receiving end configured to receive the reflected beam;
the optical transceiver comprises a circulator, the circulator includes a first port, a second port and a third port; the first port is connected to the detection beam emitting end, receives the detection beam emitted from the detection beam emitting end and transmits it to the second port; the detection beam is emitted from the second port; the second port also receives the reflected beam and transmits it to the third port; the third port is connected to the reflected beam receiving end, and transmits the reflected beam to the reflected beam receiving end.
